(19) United States
(12) Patent Application Publication
(10) Pub. No.: US 2025/0191165 A1
(43) Pub. Date: Jun. 12, 2025

(54) METHOD FOR DEFECT DETECTION OF CHIP, ELECTRONIC DEVICE, AND STORAGE MEDIUM

(71) Applicant: CHINA GREAT WALL TECHNOLOGY GROUP CO., LTD., Shenzhen (CN)

(72) Inventors: Hongbin TU, Shenzhen (CN); Jiyong YU, Shenzhen (CN); Ping ZHENG, Shenzhen (CN); Lufeng ZHANG, Shenzhen (CN); Guang YI, Shenzhen (CN); Yi ZHENG, Shenzhen (CN); Luochang ZHANG, Shenzhen (CN); Xiaojun GUO, Shenzhen (CN)

(73) Assignee: CHINA GREAT WALL TECHNOLOGY GROUP CO., LTD., Shenzhen (CN)

(21) Appl. No.: 18/959,216

(22) Filed: Nov. 25, 2024

(30) Foreign Application Priority Data
Dec. 7, 2023 (CN) 202311684208.5

(51) Int. Cl. G06T 7/00

(52) U.S. Cl. CPC G06T 7/0004; G06T 2207/20081; G06T 2207/30148

(57) ABSTRACT

A method for defect detection of a chip, an electronic device, and a storage medium. The method includes: obtaining a surface image and a package image of the chip; and inputting the surface image and the package image into a trained target detection network for performing the defect detection, thereby obtaining a surface defect and a package defect of the chip, respectively. The target detection network includes a long-range attention network and a squeeze-and-excitation network configured for determining feature weights of multiple feature channels, and an ACmix module configured for locating and recognizing a small-size target in an image. The method for defect detection of the chip is applied to enable a capability of extracting important features in the chip to be much stronger, enable the attention to the defect in the chip to be much higher, and improve an accuracy of defect detection of the chip.

### CROSS-REFERENCE TO RELATED APPLICATION

This application claims priority to Chinese patent application No. 202311684208.5, filed on Dec. 7, 2023, and entitled “Method And Apparatus For Defect Detection Of Chip, Electronic Device And Storage Medium”, the entire contents of which is incorporated herein by reference.

### TECHNICAL FIELD

The present application relates to the field of chip technologies, and more particularly, to a method for defect detection of a chip, an electronic device, and a storage medium.

### BACKGROUND

Defects in a chip generally include physical defects and electrical performance defects, where the physical defects may include a surface defect and a package defect. Currently, the surface defect and the package defect of the chip are usually detected through a target detection network.

However, the current target detection network has a relatively lower capability for extracting important features, and has a low attention to a defect of a small-size target in the chip. Thus, a much lower accuracy of the existing chip defect detection is caused.

### SUMMARY

In view of this, embodiments of the present application provide a method for defect detection of a chip, an electronic device and a storage medium, which aim at solving a technical problem that the accuracy in the existing chip defect detection is much lower.

In the first aspect, a method for defect detection of a chip is provided in one embodiment of the present application, the method includes:
obtaining a surface image and a package image of the chip; and
inputting the surface image and the package image into a trained target detection network for performing the defect detection, thereby obtaining a surface defect and a package defect of the chip, respectively; where the target detection network comprises a long-range attention network and a squeeze-and-excitation network configured for determining feature weights of multiple feature channels, and an ACmix module configured for locating and recognizing a small-size target in an image.

In one embodiment, the method further includes:
obtaining physical performance parameters of the chip;
constructing a digital twin of the chip according to the physical performance parameters;
determining electrical performance parameters of the chip according to the digital twin; and
determining an electrical performance defect of the chip according to the electrical performance parameters.

In one embodiment, the electrical performance parameters include a lead resistance, an inter-lead resistance, an inter-lead capacitance, and a lead inductance of the chip;
said determining the electrical performance defect of the chip according to the electrical performance parameters includes:
determining a lead-resistance-specification-value, an inter-lead-resistance-specification-value, an inter-lead-capacitance-specification-value and a lead-inductance-specification-value of the chip according to the physical performance parameters of the chip; and
respectively comparing the lead resistance, the inter-lead resistance, the inter-lead capacitance, and the lead inductance with the lead-resistance-specification-value, the inter-lead-resistance-specification-value, the inter-lead-capacitance-specification-value, and the lead-inductance-specification-value, and determining the electrical performance defect of the chip according to a comparison result.

In one embodiment, the target detection network is trained by using a following method comprising:
obtaining a surface-defect-image-data-set, a package-defect-image-data-set and a defect-free-image-data-set, wherein the surface-defect-image-data-set comprises a plurality of surface defect images of different surface defect categories, and the package-defect-image-data-set comprises a plurality of package defect images of different package defect categories; and
performing an optimization training on the target detection network by using the surface-defect-image-data-set, the package-defect-image-data-set and the defect-free-image-data-set as a training set.

In one embodiment, said performing the optimization training on the target detection network by using the surface-defect-image-data-set, the package-defect-image-data-set and the defect-free-image-data-set as the training set includes:
respectively inputting images in the surface-defect-image-data-set, images in the package-defect-image-data-set and images in the defect-free-image-data-set into the target detection network for performing a feature extraction processing, thereby obtaining a specified number of feature maps having different sizes and respectively corresponding to the images; and
performing an optimizing training on the target detection network through the specified number of feature maps having different sizes and respectively corresponding to the images, and defect types of the images.

In one embodiment, before said inputting the surface image and the package image into the trained target detection network for performing the defect detection, the method further includes:
performing a graying processing on the surface image and the package image;
performing a binarization processing on the surface image subjected to the gray processing and the package image subjected to the gray processing;
performing a geometric correction processing on the binarized surface image and the binarized package image; and
performing denoising and image sharpening processing on the surface image subjected to the geometric correction processing and the package image subjected to the geometric correction processing.

In one embodiment, the target detection network is an improved YOLOv7 network which uses a WIoU function as a loss function.

In the second aspect, an electronic device is provided in one embodiment of the present application. The electronic device includes a memory, a processor, and a computer program stored in the memory and executable by the processor. The processor is configured to, when executing the computer program, implement various steps of the method for defect detection of the chip.

In the third aspect, a non-transitory computer-readable storage medium is provided in one embodiment of the present application, the non-transitory computer-readable storage medium stores a computer program, that, when executed by a processor, causes the processor to implement various steps of the method for defect detection of the chip.

In the fourth aspect, a computer program product is provided in one embodiment of the present application. When the computer program product is executed by a terminal device, the terminal device is caused to perform various steps of the method for defect detection of the chip.

The method for defect detection of the chip, the electronic device, and the storage medium provided in this embodiment of the present application have the following beneficial effects:

In the method for defect detection of the chip provided in this embodiment of the present application, the surface image and the package image of the chip are obtained, then, the surface image and the package image are input into the trained target detection network which performs defect detection to obtain the surface defect and the package defect of the chip, respectively. Where, the target detection network includes the long-range attention network and the squeeze-and-excitation network configured for determining the feature weights of the multiple feature channels, and the ACmix module configured for locating and recognizing the small-size target in the image. Since the target detection network used in the present application includes the long-range attention network and the squeeze-and-excitation network configured for determining the feature weights of the multiple feature channels, and the ACmix module configured for locating and recognizing the small-size target in the image, the capability of extracting important features in the chip is much stronger, the attention to the defect in the chip is much higher, and the accuracy of defect detection of the chip is improved.

### BRIEF DESCRIPTION OF THE DRAWINGS

In order to describe the embodiments of the present application more clearly, a brief introduction regarding the accompanying drawings that need to be used for describing the embodiments of the present application or the existing technologies is given below. It is obvious that the accompanying drawings described below are merely some embodiments of the present application, a person of ordinary skill in the art may also obtain other drawings according to the current drawings without paying creative works.

FIG. 1 illustrates a flow diagram of implementation of a method for defect detection of a chip provided in one embodiment of the present application;

FIG. 2 illustrates a schematic structural diagram of a SE-ELAN module provided in one embodiment of the present application;

FIG. 3 illustrates a schematic structural diagram of an ACmix module provided in one embodiment of the present application;

FIG. 4 illustrates a schematic structural diagram of an improved YOLOv7 network provided in one embodiment of the present application;

FIG. 5 illustrates a flow diagram of a method for training a target detection network provided in one embodiment of the present application;

FIG. 6 illustrates a flow diagram of a method for determining an electrical performance defect of a chip provided in one embodiment of the present application; and

FIG. 7 illustrates a schematic structural diagram of an electronic device provided in one embodiment of the present application.

### DETAILED DESCRIPTION

It should be noted that the terms used in the embodiments of the present application are only used to explain the embodiments of the present application, rather than being intended to limit the present application. In the description of the embodiments of the present application, “multiple” refers to two or more than two, and “at least one” or “one or more” refers to one, two, or more than two, unless otherwise these phrases are explained additionally. The terms of “first” and “second” are only used for descriptive purposes and cannot be interpreted as indicating or implying relative importance or implying the number of indicated technical features. Thus, features limited by “first” and “second” may explicitly or implicitly include one or more of the features.

The descriptions of “referring to one embodiment” and “referring to some embodiments”, and the like as described in the specification of the present application means that a specific feature, structure, or characters which are described with reference to this embodiment are included in one embodiment or some embodiments of the present application. Thus, the phrases of “in one embodiment”, “in some embodiments”, “in some other embodiments”, “in other embodiments”, and the like in this specification are not necessarily referring to the same embodiment, but instead indicate “one or more embodiments instead of all embodiments”, unless otherwise these phrases are specially emphasized in other manner. The terms of “comprising”, “including”, “having” and their variations mean “including but is not limited to”, unless otherwise these terms are specially emphasized in other manner.

An executive subject of the method for defect detection of the chip provided in this embodiment of the present application may be an electronic device, where the electronic device may include a terminal device. The terminal device may include a mobile phone, a tablet computer, a notebook computer, a desktop computer, and the like.

A method for defect detection of a chip provided in this embodiment of the present application may be applied to performing defect detection of the chip, more specifically, the method for defect detection of the chip provided in this embodiment of the present application may be applied to detecting whether there exists a defect in a target chip and detecting the type of the defect that exists in the chip.

When the user needs to detect whether there exists a defect in the chip and detect the type of the existing defect, the electronic device may be used to perform various steps of the method for defect detection of the chip provided in the embodiments of the present application. Thus, whether there exists a defect in the detected chip and the type of the existing defect may be determined.

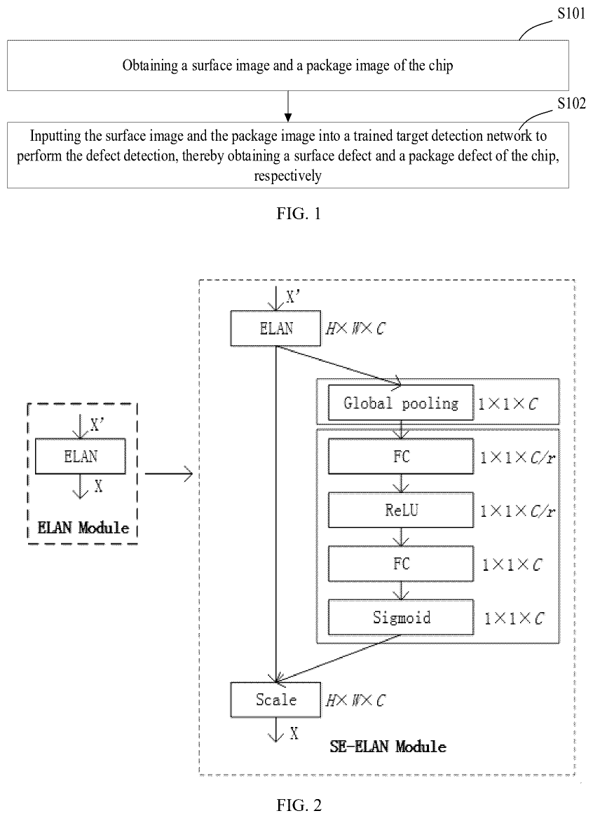

Referring to FIG. 1, FIG. 1 is a flow diagram of implementation of the method for defect detection of the chip according to one embodiment of the present application. The method for defect detection of the chip may include a step S101 and a step S102.

In the step of S101, a surface image and a package image of the chip are obtained.

In this embodiment of the present application, when the user needs to perform the defect detection on the chip, the electronic device may be used to obtain the surface image and the package image of the chip.

Where, the surface image is an image of the chip obtained by the electronic device after the chip is manufactured and before the chip is encapsulated, and the package image is an image of the chip obtained by the electronic device after the chip is packaged.

In one possible implementation method, after obtaining the surface image and the package image of the chip, before inputting the surface image and the package image into a trained target detection network for performing defect detection, the electronic device may pre-process the surface image and the package image by performing steps a-d. The steps a-d are described in detail below:

In the step a, graying processing is performed on the surface image and the package image.

In this implementation, since the surface image and the package image obtained by the electronic device are color images, a color difference may affect the accuracy of defect detection. Therefore, before the defect detection is performed, the color images need to be converted into grayscale images.

For example, this conversion may be implemented by performing weighted averaging (i.e., a weighted average method) on pixel values of different grayscale channels. In this method, pixel values of R (red), G (green) and B (blue) channels of the image are multiplied by corresponding weights, and the obtained values are summed to obtain a value as the gray value of the pixel point. When a weight coefficient is selected, the weight coefficient that enables the optimal graying effect is shown in the following formula:

$$I = 0.11 \times R ( i , j ) + 0.59 \times G ( i , j ) + 0.3 \times B ( i , j ) .$$

In the step b, a binarization processing is performed on the surface image subjected to the grayscale processing and the package image subjected to the grayscale processing.

In this embodiment, after performing the graying processing on the surface image and the package image, the electronic device may perform the binarization processing on the surface image subjected to grayscale processing and the package image subjected to grayscale processing.

For example, optimal binarization thresholds of the surface image and the package image may be automatically obtained by an OTSU method (an Otsu method). Taking the surface image as an example, it may be assumed that a binarization threshold between a pixel point of a chip pin and a pixel point of a background is Z, a proportion of the pixel point of the chip pin to the whole image may be defined as S₀, an average grayscale value of the pixel point of the chip in is a₀; a proportion of the pixel point of the background to the whole image may be defined as S1, and the average grayscale value of the pixel point of the background is a1. On this basis, the average grayscale value of the whole image of the chip is expressed as:

$$a = {s}_{0} * {a}_{0} + {s}_{1} * {a}_{1} .$$

On this basis, a target function g(z)=s₀*(a₀−a)²+s₁*(a₁−a)² is defined, where a segmentation threshold of an inter-class variance expression g (z) is z. When the value of the target function is the maximum value, the corresponding value z is the optimal binarization threshold.

In the step c, geometric correction processing is performed on the binarized surface image and the binarized package image.

In this embodiment, after performing the binarization processing on the surface image and the package image, the electronic device may perform a geometric correction processing on the binarized surface image and the binarized package image.

For example, a frame of the surface image of the chip may be detected by using a Hough transform method, and an inclination angle of an edge of the chip pin is calculated. Then, the position of the image is adjusted according to the inclination angle, the position may be kept balanced as much as possible, and the location-corrected chip image is output finally.

Where, the specific operation steps of the Hough transform method may be as follows: first, a straight line is randomly selected in an image space. Then, m points on the straight line are selected, and n straight lines are correspondingly generated in the parameter space based on an incline angle of each point. In the entire parameter space, there exists a point where M×N straight lines intersects, and this point corresponds to the incline angle in the image space. This process is represented by polar coordinates which may be expressed as:

$$ρ = cos ( θ ) * x + sin ( θ ) * y = A sin ( α + θ ) .$$

Where, ρ represents a vertical distance from an origin of coordinates to the straight line, and θ represents an included angle between the straight line and a x-axis.

The inclination angle of the edge of the pin in the surface image of the chip may be obtained through the process of the Hough transform method. Then, the position of the image is adjusted, and the corrected chip image is obtained finally. The preprocessed image may greatly improve the accuracy and the accurate rate of the chip surface defect detection model and the chip package defect detection model.

In the step d, denoising and image sharpening processing is performed on the surface image subjected to the geometric correction processing and the package image subjected to the geometric correction processing.

In this embodiment, after performing the geometric correction processing on the surface image and the package image, the electronic device may perform the denoising and image sharpening processing on the surface image subjected to the geometric correction processing and the package image subjected to the geometric correction processing.

For example, the image may be denoised by a corrosion and dilation method.

Specifically, the denoising processing may be performed by setting two different structural unit matrices, so as to effectively remove white noise points in the binarized image, in particular, process white noise points of the region of interest, thereby finally ensuring normal operation of surface defect detection algorithm and package defect detection algorithm, and avoiding misjudgment caused due to the influence of white noise points.

After the image denoising process, a Canny operator method may also be used to perform a sharpening operation on the defective image of the chip to enable the image becomes clearer, thereby facilitating implementation of the algorithm.

Where, the basic idea of the Canny operator sharpening method is that a plurality of iterative operations is firstly performed on the image of the pin region of the chip based on a nonlinear filter template, then, a derivative operator may be used to calculate derivatives of the grayed image of the chip pin in two different directions of the X axis and the Y axis to obtain a gradient amplitude and a gradient direction thereof, an expression is as follows:

$$\vert G \vert = \sqrt{( {G}_{x}^{2} + {G}_{y}^{2} )} , θ = arctan ( \frac{{G}_{y}}{{G}_{x}} ) .$$

Where, Gₓ and G_{y} are derivatives of the grayscale image of the pin in the X direction and the Y direction, respectively.

Subsequently, the gradient directions of the edge pixel points may be divided according to the horizontal direction and the vertical direction, and this operation is intended to facilitate determination of the pixel points having adjacent gradient directions. If a gray value of one pixel point is smaller than a gray value of an adjacent pixel point in the gradient direction of the pixel point, the gray value of the pixel point is set as 0, which indicates that this pixel point does not belong to the edge pixel points.

Next, a histogram method may be used to obtain two thresholds of pin region image of the chip through calculation. When a grayscale value of one pixel is smaller than the two thresholds, it indicates that the pixel is a non-edge pixel. On the contrary, when the grayscale value of the pixel is greater than the two thresholds, it indicates that this pixel is an edge pixel. Accordingly, when a grayscale value of a pixel is between the two thresholds, whether the adjacent pixel belongs to an edge pixel having high threshold needs to be checked. If it is confirmed that a grayscale value of an adjacent pixel of the pixel exceeds the high threshold, this pixel is determined as an edge pixel; otherwise, this pixel is determined as a non-edge pixel.

By performing the steps of the aforesaid Canny operator method, an edge may be recognized in the pin region image.

In the step of S102, the surface image and the package image are input into the trained target detection network in order to perform defect detection processing, thereby obtaining a surface defect and a package defect of the chip, respectively.

In this embodiment of the present application, after obtaining the preprocessed surface image and the preprocessed package image, the electronic device may input the preprocessed surface image and the preprocessed package image into the trained target detection network in order to perform defect detection processing, to respectively obtain surface defects and package defects of the chip.

Where, the target detection network includes a long-range attention network and a squeeze-and-excitation network configured for determining feature weights of multiple feature channels, and an ACmix module configured for locating and recognizing a small-size target in the image.

As an example, the long-range attention network and the squeeze-and-excitation network may be an efficient layer aggregation networks (ELAN) and a squeeze-and-excitation (SE) networks (SE-ELAN). The target detection network may be an improved YOLOv7 network, and the target detection network uses WIoU function as a loss function.

Specifically, the target detection network may include the ELAN module and the SE module (SE-ELAN module) configured for determining the feature weights of the multiple feature channels, and include an ACmix module for locating and recognizing the small-sized target in the image, and the WIoU function is used as the improved YOLOv7 network of the loss function.

The SE-ELAN module in the improved YOLOv7 network may be optimized on the basis of the ELAN module in the YOLOv7 network, and the SE module is added to enhance the ability of the network to extract the key features. The SE-ELAN module adopts a feature re-calibration strategy, such that the network can fully utilize global information. By virtue of the function of the loss function, the module may learn the feature weights autonomously, and then determine importance degrees of the multiple feature channels. Such adaptive calibration enables the module to enhance valuable feature channels and increase their weights while reducing the weights of invalid feature channels. Thus, the module may enhance key features and suppress secondary features, thereby improving a detection performance of the entire model.

For example, referring to FIG. 2, FIG. 2 illustrates a schematic structural diagram of the SE-ELAN module according to one embodiment of the present application.

The working principle of the SE-ELAN module is described below:

First, a feature map X′ with dimension information of H′×W′×C′ is provided, a feature map U with the dimension of H×W×C is generated through a convolution operation. Then, a global average pooling operation is performed on this feature map U, and the feature map U is compressed from the dimension of H×W×C to 1×1×C to obtain a parameter dimension with a global receptive field of H×W. Subsequently, by virtue of a series of fully connected layers and activation functions, the feature map is first down-sampled by a series of fully connected layers, such that the feature dimension is reduced from 1×1×C to 1×1×C/r, where r represents a scaling parameter for reducing the number of parameters of the model and accelerating model training. Then, the activation function is applied to increase the non-linear fitting capability of the network. The feature dimension is sampled from 1×1×C/r to a size of 1×1×C through another fully connected layer. Then, the value of the feature map is normalized to a range of 0 to 1 by using a sigmoid function to generate weight values. These weight values correspond to the importance of different feature channels, and different weight values represent the relative importance degrees of the multiple channels. Finally, the features of the multiple channels are weighted with the corresponding weights by performing a Scale step, to implement importance weighting processing of the features.

The ACmix module in the improved YOLOv7 network may locate and recognize a small-size target in the image, the ACmix module combines a convolution operation and a self-attention mechanism, and may effectively improve the performance of the target detection network in the detection of small-size target. By adding the ACmix module to the YOLOv7 network, the target detection network may locate and recognize defects of small-size targets in the surface image and the package image of the chip more accurately, thereby improving the accuracy of defect detection of the chip.

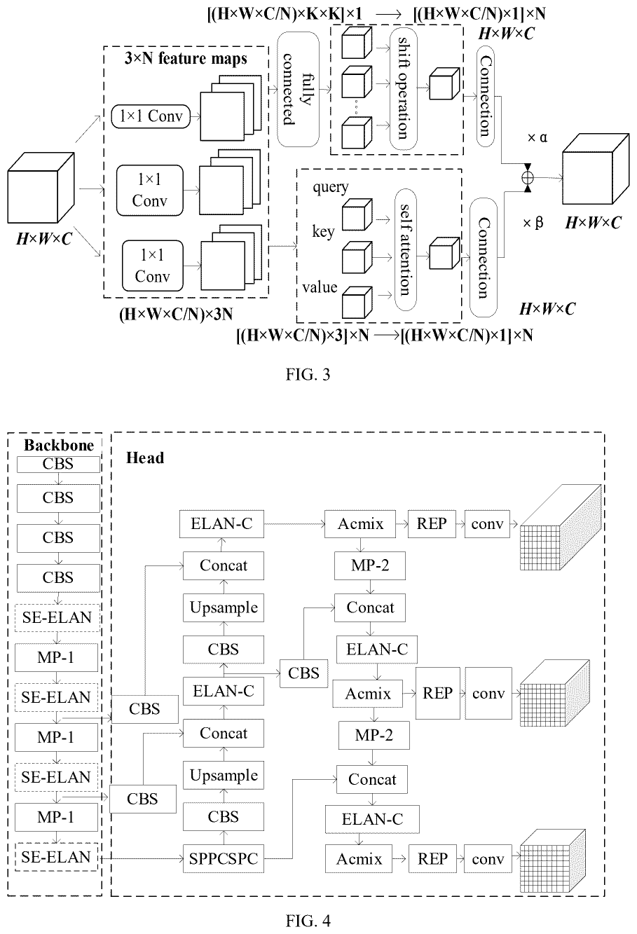

For example, referring to FIG. 3, FIG. 3 is a schematic structural diagram of an ACmix module according to one embodiment of the present application.

The working principle of the ACmix module is described below:

First, an input feature is projected through three 1×1 convolution operations, and the input feature is divided into N parts, so as to generate 3N mapped intermediate features. In the first branch, the feature information of the local receptive field is obtained through a convolution operation. After the full-connection layer processing, displacement and aggregation operations are further performed on the generated features. Next, convolution operation is performed on the processed feature to obtain a feature map with a size of H×W×C.

In the second branch, a global receptive field is obtained by using the self-attention mechanism, and a key region is more emphasized. This involves mapping 3N intermediate features into three feature maps which are named Query, Key, and Value, respectively. The feature maps follow a multi-head self-attention module, after the convolution operation, a feature map with the size of H×W×C is obtained.

Finally, outputs of the first and second branches are summed, and an intensity of the fusion is controlled by two learnable scalar parameters. By performing this operation, the network may combine the features of the local receptive field with the global receptive field better, thereby improving the attention and detection performance of the small-size target.

$${F}_{o u t} = α {F}_{a t t} + β {F}_{c o n v} .$$

Where, Fₒᵤₜ is the last output result in the ACmix module, Fₐₜₜ, F_{conv} are output results of a self-attention path and a convolution path, respectively. Values of α and β are set to 1. The ACmix integrates the advantages of the convolution module and the self-attention module, acts on the Head part in the YOLOv7 network. The attention mechanism is used to weight prediction results of different bounding boxes. The importances of different bounding boxes are dynamically adjusted according to the feature representation or confidence of each of the bounding boxes, so as to improve the attention of the small size target, the condition of missing detection generated when the network model detects the small target is reduced, and the overall detection accuracy is improved.

Since an image of a defective chip causes a low-quality sample weighting penalty in the photographing process due to various external environmental factors, and an insufficient generalization ability of the model is caused. Aiming at this problem, the WIoU function is used in the improved YOLOv7 network as a loss function, and an outlier value β is used instead of IoU to evaluate the quality of anchor box.

Where, the definition of the WIoU function in this embodiment of the present application may be represented by using the following formula which is expressed as:

$$β = \frac{{L}_{IoU}^{*}}{\overline{{L}_{IoU}}} ∈ [ 0 , + ∞ ) ;$$

$${L}_{WIoUv 3} = r {L}_{WIoUv 1} , r = \frac{β}{δ {α}^{β - δ}} .$$

Where, L_{IoU}* represents a monotonic focusing coefficient of the original L_{WIoUv1}, L̅_̅{̅I̅o̅U̅}̅ represents a sliding average value of a momentum of M, a non-monotonic focusing coefficient r is constructed by using β, which is applied to WIoUv1, L_{WIoUv1}=R_{WIou}L_{IoU},

$${R}_{WIoU} = exp ( \frac{{( x - {x}_{g t} )}^{2} + {( y - {y}_{g t} )}^{2}}{{( {W}_{g}^{2} + {H}_{g}^{2} )}^{*}} ) .$$

Where, Wg, Hg are sizes of the boxes, a and y are hyper-parameters, R_{WIoU}∈[1, e) is represented as L_{IoU} for amplifying an anchor box with a common quality; L_{IoU}∈[0,1] is represented as R_{WIoU} for reducing an anchor box with a high quality, and significantly reduces its attention to the center point distance when the anchor box coincides with the target box. An anchor box having a small β value is high in quality, and WIoU allocates a small gradient gain to the anchor box having small β value. Thus, the bounding box regression is focused on the anchor box with common quality. An anchor box having a greater β value is low in quality, WIoU allocates a small gradient gain to the anchor box with low quality so as to reduce the harmful gradient and focus on the anchor box with the common quality, thereby improving the generalization ability of the model.

On this basis, referring to FIG. 4, FIG. 4 is a schematic structural diagram of an improved YOLOv7 network according to one embodiment of the present application.

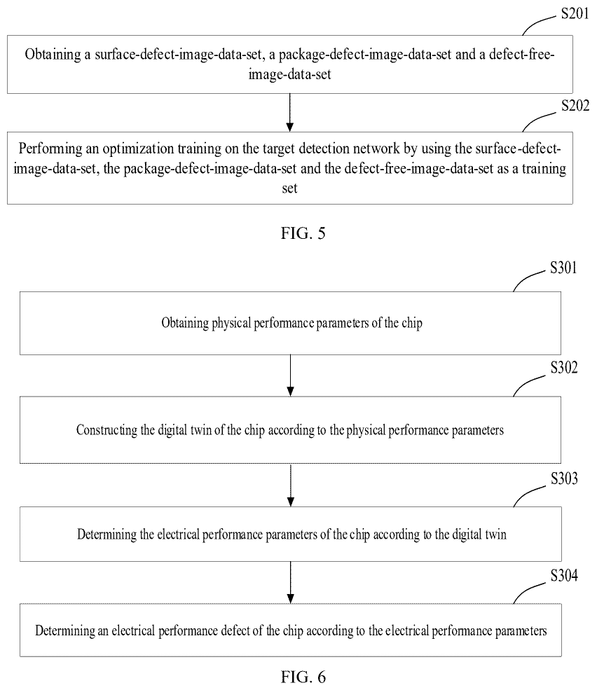

After constructing the target detection network (e.g., the ELAN module and the SE module (SE-ELAN module) configured for determining the feature weights of the multiple feature channels provided in the aforesaid embodiments, and including the ACmix module configured for locating and recognizing the small-size target in the image, and using the WIoU function as the YOLOv7 network of the loss function), the target detection network may be trained by performing steps S201-S202 as shown in FIG. 5. FIG. 5 is a flow diagram of a method for training a target detection network according to one embodiment of the present application. This method is described in detail below:

In a step of S201, a surface-defect-image-data-set, a package-defect-image-data-set, and a defect-free-image-data-set are obtained.

Where, the surface-defect-image-data-set includes a plurality of surface defect images of different surface defect categories, and the package-defect-image-data-set includes a plurality of package defect images of different package defect categories.

In this embodiment of the present application, defects in the chip may be classified in advance. For example, the surface defects of the chip may include the following types: poor quality of raw material, existence of foreign matter, scratches, bump element defects (protrusion, dislocation or missing), metal pollution, residues of etching solution, etching rust spots, excessive electroplating, heterochrome phenomenon, metal wire damage, and the like. Package defects of the chip may include the following types: printing defect, pin missing, pin breakage, pin bending, and the like.

Then, a plurality of images having the aforesaid defect types and defect-free images that do not have any defect may be obtained, the defect types in each image are labeled. Then, the corresponding types of images are placed in the corresponding type of data set, so as to obtain the surface-defect-image-data-set, the package-defect-image-data-set, and the defect-free-image-data-set.

For example, several defective images having the defect type of poor raw material quality are obtained, and this image is put into the surface-defect-image-data-set; for example, several defective images having the defect type of printing defect are obtained, and this image is put into the package-defect-image-data-set; for example, several defect-free images that do not have any defect are obtained, and the image is put into the defect-free-image-data-set.

In the step of S202, optimization training is performed on the target detection network by using the surface-defect-image-data-set, the package-defect-image-data-set and the defect-free-image-data-set as a training set.

In this embodiment of the present application, after the surface-defect-image-data-set, the package-defect-image-data-set, and the defect-free-image-data-set are obtained, optimization training may be performed on the target detection network by using the surface-defect-image-data-set, the package-defect-image-data-set, and the defect-free-image-data-set as a training set, in this way, the target detection network may recognize whether there exists a defect in the image and the specific type of the defect in the image. For example, the target detection network subjected to the optimization training may obtain the surface image and/or the package image, and then determine whether there exists a defect in the image, and further output the specific type of the defect if there exists the defect (e.g., the various types of defects provided in the embodiment mentioned above).

In one possible embodiment, optimization training may be performed on the target detection network by using the following steps e-f which are described below:

In the step e, the images in the surface-defect-image-data-set, the images in the package-defect-image-data-set and the images in the defect-free-image-data-set are respectively input to the target detection network for feature extraction processing so as to obtain a specified number of feature maps having different sizes corresponding to the images.

Specifically, a feature map of any image may be obtained in the following manner:

Firstly, the input picture may be preprocessed, and the size may be reset and input into a backbone network in the target detection network. As shown in FIG. 4, the input data sequentially passes through a CBS module having a convolution kernel size of 3 and a step length of 1 and a CBS module having a convolution kernel size of 3 and a step length of 2, after passing through the two CBS twice, the input data is changed to a size of 160×160×128. After passing through four CBS modules, and when passing through the improved SE-ELAN module again, since the ELAN is constituted of a plurality of CBS, the input/output feature dimension of the CBS module remains unchanged, and the number of channels will increase by two times to become 160×160×256 due to concat tensor splicing, MP-1 is mainly consisted of max pooling layer Maxpool and CBS modules, the feature dimension is reduced while the number of channels is unchanged, and the size of the input data becomes 80×80×256. Then, the input data passes through the SE-ELAN layer and the size of the input data is changed to 80×80×512. Then, the input data passes through output of two MP-1 and SE-ELAN, and the output size is 40×40×1024, that is, C4 and 20×20×1024. Regarding the 32-time down-sampling feature map C5 finally output by the Backbone, the number of channels becomes 512 after passing through SPPCSPC, then, three feature maps having the sizes of 80×80, 40×40, and 20×20 are respectively output.

In the step f, optimization training is performed on the target detection network according to the specified number of feature maps having different sizes and corresponding to each image, and the defect types included in each image.

In this embodiment, after the specified number of feature maps having different sizes and corresponding to each image are obtained, optimization training may be performed on the target detection network by using the specified number of feature maps having different sizes and corresponding to each image, and the defect types included in each image.

Specifically, a mapping relationship between the specified number of feature maps having different sizes and corresponding to each image and the defect types included in each image may be input into the target detection network. Then, optimization training is performed on the target detection network.

It can be learned from the above descriptions that in the method for defect detection of the chip provided in this embodiment of the present application, the surface image and the package image of the chip are obtained, and then the surface image and the package image are input into the trained target detection network for defect detection processing, so as to obtain the surface defect and the package defect of the chip, respectively. Where, the target detection network includes the long-range attention network and the squeeze-and-excitation network configured for determining the feature weights of the multiple feature channels, and the ACmix module is configured to locate and recognize the small-size target in the image. Since the target detection network used in the present application includes the long-range attention network and the squeeze-and-excitation network configured for determining the feature weights of the multiple feature channels, and the ACmix module configured for locating and recognizing the small-size target in the image, the extraction capability of important features in the chip is relatively higher, the attention to the defect in the chip is relatively higher, and the accuracy of defect detection of the chip is improved.

In this embodiment of the present application, in addition to obtaining the surface defect and the package defect of the chip, the electronic device may further determine the electrical performance defect of the chip by performing steps S301-S304 shown in FIG. 6. FIG. 6 is a flow diagram of a method for determining an electrical performance defect of a chip according to one embodiment of the present application. The method is described in detail below:

In the step of S301, physical performance parameters of the chip are obtained.

In this embodiment of the present application, the physical performance parameters of the chip are the parameters required for constructing a digital twin of the chip, and the specific physical performance parameter may be set according to the actual requirement, and is not limited herein.

In the step of S302, the digital twin of the chip is constructed according to the physical performance parameters.

In this embodiment of the present application, after obtaining the physical performance parameters of the chip, the electronic device may construct the digital twin of the chip based on the physical performance parameters of the chip.

Specifically, a three-dimensional geometric model of the chip after encapsulation of the chip may be constructed according to physical performance parameters, where the three-dimensional geometric model may include a chip, a circuit board, a through hole, a lead, and the like. Then, a digital model of characteristic parameterization during actual operation of the multi-chip modules of a digital space may be established, and a digital twin of the chip is constructed accordingly.

In the step of S303, the electrical performance parameters of the chip are determined according to the digital twin.

In this embodiment of the present application, after obtaining the digital twin, the electronic device may determine the electrical performance parameters of the chip based on the constructed digital twin.

The electrical performance parameters of the chip include a lead resistance, an inter-lead resistance, an inter-lead capacitance and a lead inductance of the chip.

An expression of the lead resistance is listed below:

$$R = ρ l / db ( Ω ) .$$

Where, R represents the lead resistance (Ω), ρ represents a resistivity of the lead material, d represents a thickness of the lead material, l represents a length of the lead material, and b represents a width of the lead material.

On this Basis, the lead resistance of the chip may be determined by obtaining the resistivity of the lead material, the thickness of the lead material, the length of the lead material and the width of the lead material in the digital twin.

The inter-lead resistance is the inter-lead insulation resistance, and the actual measurement method is implemented by using a high resistance instrument, a bridge or an insulation resistance measuring instrument to test disconnected leads after continuously applying a test voltage for a specified time, thereby directly obtaining the inter-lead resistance in the digital twin.

An expression of the inter-lead capacitance is listed below:

$$C = πε l / ln ( d / r ) .$$

Where, C represents a capacitance (pF) between two leads, l represents a length of the lead (cm), c represents a dielectric constant of an insulator between the two leading wires, d represents a distance (cm) between the two leads, and r represents a radius of the lead.

On this basis, the inter-lead capacitance of the chip may be determined by obtaining the capacitance, the length of the lead, the dielectric constant of the insulator between the two leads, the distance between the two leads, and the radius of the lead in the digital twin.

The lead inductance may be determined in the following manner:

Regarding the lead having a circular cross-section, when L<100d, an inductance L is expressed as:

$$L = 2 l [ ln ( \frac{4 l}{d} ) - 1 + d / 21 ] .$$

Where, L represents a lead inductance (nH) having a circular cross-section, L represents a length (cm) of the lead having the circular cross-section, and d represents a diameter (cm) of the lead having the circular cross-section. Under the same condition, an inductance L of a lead having a rectangular cross-section is expressed as:

$$L = 2 l \{ ln [ \frac{2 l}{b + c} ] + 0.5 + 0.2235 [ ( b + c ) / l ] \} .$$

Where, L represents a lead inductance (nH) having a rectangular cross-section, L represents a length (cm) of the lead having the rectangular cross-section, D represents a width (cm) of the lead having the rectangular cross-section, and c represents a thickness of the lead having the rectangular cross-section.

In the step of S304, an electrical performance defect of the chip is determined according to the electrical performance parameters.

In this embodiment of the present application, after determining the electrical performance parameters of the chip based on the digital twin, the electrical performance defect of the chip may be determined based on the determined electrical performance parameters.

Specifically, the obtained lead resistance, the obtained inter-lead resistance, the obtained inter-lead capacitance, and the obtained lead inductance may be compared with the lead-resistance-specification-value, the inter-lead-resistance-specification-value, the inter-lead-capacitance-specification-value, and the lead-inductance-specification-value, respectively, and the electrical performance defect of the chip is determined according to the comparison result.

For example, referring to table 1, table 1 illustrates a schematic diagram of lead-resistance-specification-value according to one embodiment of the present application.

TABLE 1
lead-resistance-specification-value

| | Number of leads | | | | | | | |
|---|---|---|---|---|---|---|---|---|
| | 8, 14, 16, 18 | 20, 22 | 24 | 28 | 40 | 42 | 48 | 64 |
| Specification | 0.2 | 0.25 | 0.3 | 0.35 | 0.4 | 0.6 | 0.7 | 0.8 |
| (Ω) of lead | | | | | | | | |

A corresponding lead-resistance-specification-value may be obtained from table 1 according to the number of leads. If the lead resistance is greater than the obtained lead-resistance-specification-value, it may be determined that the chip has an electrical performance defect.

For example, referring to table 2, table 2 illustrates a schematic diagram of an inter-lead-resistance-specification-value according to one embodiment of the present application.

TABLE 2
requirements and standards for inter-lead resistance test

| Requirement | | |
|---|---|---|
| on the level | | |
| of inter-lead | National standards | National military standards |
| resistance | (GB6649-86) | (GJB548A-96) |
| A: 1 × 10⁸Ω | Condition 1: 50 ± 1 V | test condition A: 10 V ± 10% |
| B: 1 × 10⁹Ω | Condition 2: 100 ± 1 | test condition B: 25 V ± 10% |
| | V | |
| C: 1 × 10¹⁰Ω | Condition 3: 500 ± 1 | test condition C: 50 V ± 10% |
| | V | |
| D: 1 × 10¹¹Ω | | test condition D: 100 V ± 10% |
| E: 1 × 10¹²Ω | | test condition E: 500 V ± 10% |
| | | test condition F: 1000 V ± 10% |

A corresponding inter-lead-resistance-specification-value may be obtained according to the test condition. For example, when the test condition is the condition 1: 50±1V under the national standard, the inter-lead-resistance-specification-value is 1×10⁸Ω. If an inter-lead-resistance-value is less than the obtained inter-lead-resistance-specification-value, it may be determined that the chip has an electrical performance defect.

The inter-lead-capacitance-specification-value may be obtained with reference to the example described above, and the inter-lead capacitance may be compared with the inter-lead-capacitance-specification-value. If the inter-lead capacitance is greater than the inter-lead-capacitance-specification-value, it may be determined that the chip has an electrical performance defect. The lead-inductance-specification-value may be obtained with reference to the example described above, and the lead inductance may be compared with the lead-inductance-specification-value. If the lead inductance is greater than the lead-inductance-specification-value, it may be determined that the chip has an electrical performance defect.

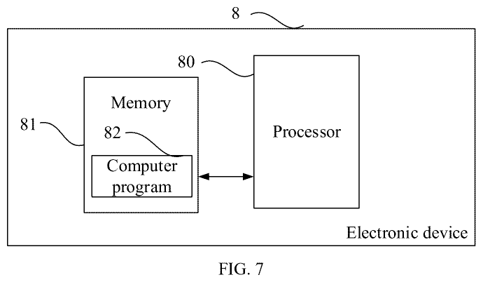

Referring to FIG. 7, FIG. 7 illustrates a schematic structural diagram of an electronic device provided in one embodiment of the present application. As shown in FIG. 7, the electronic device 8 provided in this embodiment may include a processor 80, a memory 81, and a computer program 82 stored in the memory 81 and executable by the processor 80, such as the program corresponding to the defection detection method of the chip. The processor 80 is configured to, when executing the computer program 82, implement the steps in the method for defect detection of the chip, such as steps S101-102 shown in FIG. 1, the steps S201-S202 shown in FIG. 5, and the steps S301-S304 shown in FIG. 6.

A person of ordinary skill in the art may understand that, FIG. 7 is only one example of the electronic device 8, and does not constituted as limitation to the electronic device 8. More or less components than the components shown in FIG. 7 may be included, alternatively, some components or different components may be combined.

The processor 80 may be central processing unit (CPU), and may also be other general purpose processor, digital signal processor (DSP), application specific integrated circuit (ASIC), field-programmable gate array (FGPA), or some other programmable logic devices, discrete gate or transistor logic device, discrete hardware component, etc. The general purpose processor may be a microprocessor, as an alternative, the processor may also be any conventional processor, or the like.

The memory 81 may be an internal storage unit of the electronic device 8, such as a hard disk or a memory of the electronic device 8. The memory 81 may also be an external storage device of the electronic device 8, such as a plug-in hard disk, a smart media card (Smart Media Card, SMC), a secure digital (Secure Digital, SD) card, a flash card (Flash Card, FC) equipped on the electronic device 8. Furthermore, the memory 81 may not only include the internal storage unit of the electronic device 8, but also include the external memory of the electronic device 8. The memory 81 is configured to store the computer program, and other procedures and data as required by the electronic device 8. The memory 81 may also be configured to store data that has been output or being ready to be output temporarily.

A non-transitory computer-readable storage medium is further provided in one embodiment of the present application. The non-transitory computer-readable storage medium stores a computer program, that, when executed by the processor, implements the steps in the various method embodiments.

A computer program product is further provided in one embodiment of the present application. When the computer program product is executed by a terminal device, the terminal device is caused to implement the steps in the various method embodiments.

In the aforesaid embodiments, the descriptions of the various embodiments are emphasized respectively. Regarding a part of one embodiment which has not been described or disclosed in detail, reference can be made to relevant descriptions in other embodiments.

The person of ordinary skill in the art may understand that, the elements and algorithm steps of each of the examples described in connection with the embodiments disclosed herein may be implemented in electronic hardware, or in combination with computer software and electronic hardware. Whether these functions are implemented by hardware or software depends on the specific application and design constraints of the technical solution. The person of ordinary skill in the art could use different methods to implement the described functions for each particular application, however, such implementations should not be considered as going beyond the scope of the present application.

The aforesaid embodiments are only intended to explain the technical solutions of the present application, rather than limiting the technical solutions of the present application. Although the present application has been described in detail with reference to these embodiments, a person of ordinary skilled in the art should understand that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions in the embodiments of the present application, and thus should all be included in the protection scope of the present application.

What is claimed is:

1. A method for defect detection of a chip implemented by an electronic device, comprising:
obtaining a surface image and a package image of the chip; and
inputting the surface image and the package image into a trained target detection network for performing the defect detection, thereby obtaining a surface defect and a package defect of the chip, respectively; wherein the target detection network comprises a long-range attention network and a squeeze-and-excitation network configured for determining feature weights of multiple feature channels, and an ACmix module configured for locating and recognizing a small-size target in an image.

2. The method according to claim 1, further comprising:
obtaining physical performance parameters of the chip;
constructing a digital twin of the chip according to the physical performance parameters;
determining electrical performance parameters of the chip according to the digital twin; and
determining an electrical performance defect of the chip according to the electrical performance parameters.

3. The method according to claim 2, wherein the electrical performance parameters comprise a lead resistance, an inter-lead resistance, an inter-lead capacitance, and a lead inductance of the chip;
said determining the electrical performance defect of the chip according to the electrical performance parameters comprises:
determining a lead-resistance-specification-value, an inter-lead-resistance-specification-value, an inter-lead-capacitance-specification-value and a lead-inductance-specification-value of the chip according to the physical performance parameters of the chip; and
respectively comparing the lead resistance, the inter-lead resistance, the inter-lead capacitance, and the lead inductance with the lead-resistance-specification-value, the inter-lead-resistance-specification-value, the inter-lead-capacitance-specification-value, and the lead-inductance-specification-value, and determining the electrical performance defect of the chip according to a comparison result.

4. The method according to claim 1, wherein the target detection network is trained in a following method comprising:
obtaining a surface-defect-image-data-set, a package-defect-image-data-set and a defect-free-image-data-set, wherein the surface-defect-image-data-set comprises a plurality of surface defect images of different surface defect categories, and the package-defect-image-data-set comprises a plurality of package defect images of different package defect categories; and
performing an optimization training on the target detection network by using the surface-defect-image-data-set, the package-defect-image-data-set and the defect-free-image-data-set as a training set.

5. The method according to claim 4, wherein said performing the optimization training on the target detection network by using the surface-defect-image-data-set, the package-defect-image-data-set and the defect-free-image-data-set as the training set comprises:
respectively inputting images in the surface-defect-image-data-set, images in the package-defect-image-data-set and images in the defect-free-image-data-set into the target detection network for performing a feature extraction processing, thereby obtaining a specified number of feature maps having different sizes and respectively corresponding to the images; and
performing an optimizing training on the target detection network through the specified number of feature maps having different sizes and respectively corresponding to the images, and defect types of the images.

6. The method according to claim 1, wherein before said inputting the surface image and the package image into the trained target detection network for performing the defect detection, the method further comprises:
performing a graying processing on the surface image and the package image;
performing a binarization processing on the surface image subjected to the gray processing and the package image subjected to the gray processing;
performing a geometric correction processing on the binarized surface image and the binarized package image; and
performing denoising and image sharpening processing on the surface image subjected to the geometric correction processing and the package image subjected to the geometric correction processing.

7. The method according to claim 1, wherein the target detection network is an improved YOLOv7 network which uses a WIoU function as a loss function.

8. An electronic device, comprising a memory, a processor, and a computer program stored in the memory and executable by the processor, wherein the processor is configured to, when executing the computer program, implement steps of a method for defect detection of a chip, comprising:
obtaining a surface image and a package image of the chip; and
inputting the surface image and the package image into a trained target detection network for performing the defect detection, thereby obtaining a surface defect and a package defect of the chip, respectively; wherein the target detection network comprises a long-range attention network and a squeeze-and-excitation network configured for determining feature weights of multiple feature channels, and an ACmix module configured for locating and recognizing a small-size target in an image.

9. A non-transitory computer-readable storage medium, which stores a computer program, that, when executed by a processor of an electronic device, causes the processor of the electronic device to implement steps of the method for defect detection of the chip according to claim 1.

10. The electronic device according to claim 8, wherein the processor is further configured to perform steps of:
obtaining physical performance parameters of the chip;
constructing a digital twin of the chip according to the physical performance parameters;
determining electrical performance parameters of the chip according to the digital twin; and
determining an electrical performance defect of the chip according to the electrical performance parameters.

11. The electronic device according to claim 10, wherein the electrical performance parameters comprise a lead resistance, an inter-lead resistance, an inter-lead capacitance, and a lead inductance of the chip;
the processor is particularly configured to perform the step of determining the electrical performance defect of the chip according to the electrical performance parameters by:
determining a lead-resistance-specification-value, an inter-lead-resistance-specification-value, an inter-lead-capacitance-specification-value and a lead-inductance-specification-value of the chip according to the physical performance parameters of the chip; and
respectively comparing the lead resistance, the inter-lead resistance, the inter-lead capacitance, and the lead inductance with the lead-resistance-specification-value, the inter-lead-resistance-specification-value, the inter-lead-capacitance-specification-value, and the lead-inductance-specification-value, and determining the electrical performance defect of the chip according to a comparison result.

12. The electronic device according to claim 8, wherein the target detection network is trained by using a following method comprising:
obtaining a surface-defect-image-data-set, a package-defect-image-data-set and a defect-free-image-data-set, wherein the surface-defect-image-data-set comprises a plurality of surface defect images of different surface defect categories, and the package-defect-image-data-set comprises a plurality of package defect images of different package defect categories; and
performing an optimization training on the target detection network by using the surface-defect-image-data-set, the package-defect-image-data-set and the defect-free-image-data-set as a training set.

13. The electronic device according to claim 12, wherein the processor is particularly configured to perform the step of performing the optimization training on the target detection network by using the surface-defect-image-data-set, the package-defect-image-data-set and the defect-free-image-data-set as the training set by:
respectively inputting images in the surface-defect-image-data-set, images in the package-defect-image-data-set and images in the defect-free-image-data-set into the target detection network for performing a feature extraction processing, thereby obtaining a specified number of feature maps having different sizes and respectively corresponding to the images; and
performing an optimizing training on the target detection network through the specified number of feature maps having different sizes and respectively corresponding to the images, and defect types of the images.

14. The electronic device according to claim 8, wherein before the step of inputting the surface image and the package image into the trained target detection network for performing the defect detection, the processor is further configured to perform steps of:
performing a graying processing on the surface image and the package image;
performing a binarization processing on the surface image subjected to the gray processing and the package image subjected to the gray processing;
performing a geometric correction processing on the binarized surface image and the binarized package image; and
performing denoising and image sharpening processing on the surface image subjected to the geometric correction processing and the package image subjected to the geometric correction processing.

15. The electronic device according to claim 8, wherein the target detection network is an improved YOLOv7 network which uses a WIoU function as a loss function.
